(19) United States
(12) Patent Application Publication
(10) Pub. No.: US 2026/0229560 A1
(43) Pub. Date: Aug. 6, 2026

(54) FUEL CELL SYSTEM

(71) Applicant: TOYOTA BOSHOKU KABUSHIKI KAISHA, Aichi-ken (JP)

(72) Inventors: Kensuke DOI, Obu-shi (JP); Kazuyuki HIRATA, Toyota-shi (JP)

(73) Assignee: TOYOTA BOSHOKU KABUSHIKI KAISHA, Aichi-ken (JP)

(21) Appl. No.: 19/448,415

(22) Filed: Jan. 14, 2026

(30) Foreign Application Priority Data
Feb. 4, 2025 (JP) 2025-016670

(51) Int. Cl. H01M 8/04082

(52) U.S. Cl. CPC H01M 8/04208; H01M 8/04216

(57) ABSTRACT

A fuel cell system includes a fuel cell, a canister, and a holder. The canister incorporates a hydrogen storage alloy that stores and releases hydrogen gas. The canister supplies hydrogen gas to the fuel cell. The canister is removably accommodated in the holder. The fuel cell system is configured to heat the canister using waste heat of the fuel cell. The canister is formed of aluminum or an aluminum alloy. A first anodized layer is formed on an outer surface of the canister.

### CROSS-REFERENCE TO RELATED APPLICATIONS

This application is based upon and claims the benefit of priority from Japanese Patent Application No. 2025-16670, filed on Feb. 4, 2025, the entire contents of which are incorporated herein by reference.

### BACKGROUND

### 1. Field

The present disclosure relates to a fuel cell system.

### 2. Description of Related Art

A fuel cell system is known in which a canister incorporating a hydrogen storage alloy for supplying hydrogen gas to a fuel cell is heated by waste heat generated from the fuel cell. The fuel cell system includes a holder in which the canister is removably accommodated.

When the hydrogen storage alloy releases hydrogen gas, an endothermic reaction occurs, causing a decrease in the temperature of the hydrogen storage alloy. As the temperature of the hydrogen storage alloy decreases, the amount of hydrogen gas released from the hydrogen storage alloy, and thus the amount of hydrogen gas supplied to the fuel cell, also decreases.

JP2007-45301A discloses an electric wheelchair including a fuel cell body, a hydrogen cylinder incorporating a hydrogen storage alloy, and a cylinder holding member in which the hydrogen cylinder is removably accommodated. In this electric wheelchair, gas heated by waste heat from the fuel cell body is guided through a gas guide portion into a space between the inner surface of the cylinder holding member and the outer surface of the hydrogen cylinder. As a result, the hydrogen cylinder is heated, thereby suppressing a decrease in the amount of hydrogen gas supplied to the fuel cell body.

When the canister is attached to or detached from the holder, the canister may come into contact with the holder, potentially causing damage to the canister. To protect the canister, forming a coating film on the outer surface of the canister using a resin coating material has been considered. However, forming such a coating film may reduce the thermal conductivity of the outer surface of the canister, thereby decreasing the heating efficiency of the canister by the waste heat from the fuel cell. Accordingly, it is desirable to provide both protection for the outer surface of the canister and suppression of any reduction in the thermal conductivity of the canister.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a fuel cell system includes a fuel cell, a canister, and a holder. The canister incorporates a hydrogen storage alloy that stores and releases hydrogen gas. The canister is configured to supply hydrogen gas to the fuel cell. The canister is removably accommodated in the holder. The fuel cell system is configured to heat the canister using waste heat of the fuel cell. The canister is formed of aluminum or an aluminum alloy. An anodized layer is formed on an outer surface of the canister.

Other features and aspects will be apparent from the following detailed description, the drawings, and the claims.

### BRIEF DESCRIPTION OF THE DRAWINGS

FIG. 1 is a schematic diagram showing a fuel cell system according to an embodiment.

FIG. 2 is a cross-sectional view showing an internal flow passage of the holder shown in FIG. 1.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

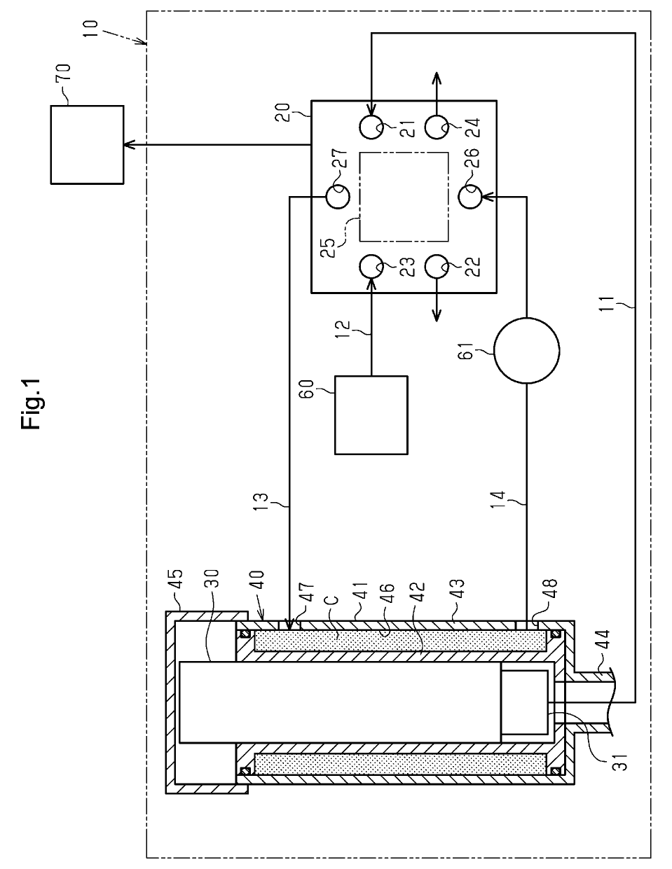

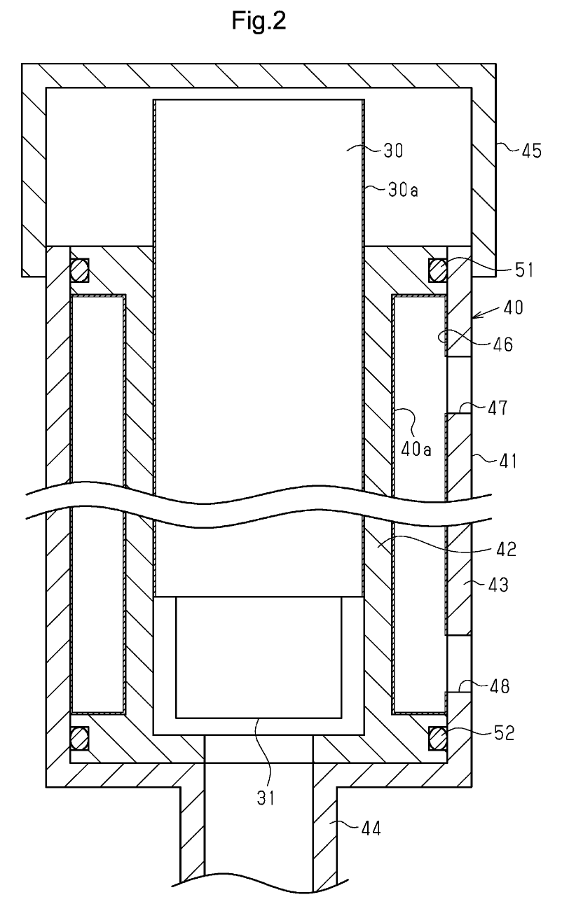

A fuel cell system 10 according to an embodiment will now be described with reference to FIGS. 1 and 2.

### Configuration of the Fuel Cell System 10

As shown in FIG. 1, the fuel cell system 10 includes a fuel cell 20, a canister 30, a holder 40, a compressor 60, and a pump 61.

The fuel cell 20 supplies electric power to an external load 70. The external load 70 is, for example, a motor driven by electric power. The canister 30 supplies fuel gas to the fuel cell 20. The canister 30 is removably accommodated in the holder 40. The compressor 60 supplies oxidant gas to the fuel cell 20. The pump 61 supplies coolant C such as water to the fuel cell 20. The coolant C is an example of a heating medium.

### Configuration of the Fuel Cell 20

The fuel cell 20 includes a fuel gas supply port 21, through which the fuel gas is supplied, a fuel gas discharge port 22, through which the fuel gas is discharged, an oxidant gas supply port 23, through which the oxidant gas is supplied, and an oxidant gas discharge port 24, through which the oxidant gas is discharged. The fuel gas supply port 21 is connected to the canister 30 via a first gas pipe 11. The oxidant gas supply port 23 is connected to the compressor 60 via a second gas pipe 12.

The fuel cell 20 is, for example, a polymer electrolyte fuel cell including a power generating unit 25 including a membrane electrode assembly (not shown). The power generating unit 25 is disposed at the center of the fuel cell 20. Fuel gas supplied to the fuel gas supply port 21 passes through the power generating unit 25 and is discharged from the fuel gas discharge port 22 to the outside of the fuel cell 20. Oxidant gas supplied to the oxidant gas supply port 23 passes through the power generating unit 25 and is discharged to the outside of the fuel cell 20 from the oxidant gas discharge port 24. The power generating unit 25 generates electric power from the electrochemical reaction between the fuel gas and the oxidant gas. The fuel gas is, for example, hydrogen gas. The oxidant gas is, for example, air.

The fuel cell 20 includes a coolant supply port 26, through which the coolant C is supplied, and a coolant discharge port 27, through which the coolant C is discharged. The coolant C flowing through the interior of the fuel cell 20 cools the fuel cell 20, which generates heat with power generation of the power generating unit 25.

### Configuration of the Canister 30

The canister 30 is a cylindrical container having an internal space. The canister 30 is made of aluminum or an aluminum alloy.

The canister 30 contains a hydrogen storage alloy that stores and releases hydrogen gas. The canister 30 includes a discharge port 31 for discharging hydrogen gas at one end in the longitudinal direction. The first gas pipe 11 is connected to the discharge port 31. The canister 30 supplies hydrogen gas released from the hydrogen storage alloy to the fuel cell 20 via the first gas pipe 11.

When the hydrogen storage alloy releases hydrogen gas, an endothermic reaction occurs, causing a decrease in the temperature of the hydrogen storage alloy. When the temperature of the hydrogen storage alloy decreases, the pressure in the canister 30 decreases, so that the amount of hydrogen gas released from the hydrogen storage alloy decreases. In the present embodiment, the coolant C is circulated through the circulation passage between the fuel cell 20 and the holder 40 so as to suppress a decrease in the temperature of the hydrogen storage alloy.

As shown in FIG. 2, a first anodized layer 30a is formed on the outer surface of the canister 30, specifically, the entire outer circumferential surface of the canister 30. The first anodized layer 30a is an anodic oxide film formed on the outer surface of the canister 30 by an anodizing process. The thermal conductivity of the first anodized layer 30a is lower than that of the base material of the canister 30, which is made of aluminum or an aluminum alloy.

### Configuration of the Holder 40

The holder 40 has a cylindrical shape with a closed upper end. The canister 30 is accommodated in the holder 40 such that the discharge port 31 is directed downward. The holder 40 includes a cylindrical peripheral wall 41 that holds the outer circumferential surface of the canister 30.

The holder 40 includes a cylindrical inner tube 42, a cylindrical outer tube 43, and a cap 45. The inner tube 42 accommodates the canister 30. The outer tube 43 accommodates the inner tube 42. The cap 45 covers an upper end of the canister 30 and is attached to an upper end of the outer tube 43. The peripheral wall 41 of the holder 40 includes the inner tube 42 and the outer tube 43, which can be separated from each other. The inner tube 42, the outer tube 43, and the cap 45 are made of aluminum or an aluminum alloy.

The inner circumferential surface of the inner tube 42 is in contact with the outer circumferential surface of the canister 30 over the entire circumference. An upper end of the canister 30 protrudes from an upper opening of the inner tube 42.

An external thread (not shown) is formed on the entire outer circumferential surface of the upper end portion of the outer tube 43. The outer tube 43 includes a lead-out port 44 at the lower end, through which the first gas pipe 11 (see FIG. 1) connected to the discharge port 31 is drawn out. The lead-out port 44 communicates with the lower opening of the inner tube 42.

The cap 45 is dome-shaped. An internal thread (not shown) that meshes with the external thread of the outer tube 43 is formed on the inner circumferential surface of the cap 45. The cap 45 is removably attached to the outer tube 43 by engagement between the internal thread of the cap 45 and the external thread of the outer tube 43.

A base material made of aluminum or an aluminum alloy is exposed on the inner surface of the holder 40, specifically, on the inner surface of the inner tube 42 and the inner surface of the cap 45. The base material includes a substrate of aluminum or an aluminum alloy and a naturally formed oxide film produced on a surface of the substrate by reaction with oxygen in the air. The inner circumferential surface of the inner tube 42, on which the base material is exposed, is in contact with the first anodized layer 30a over the entire circumference.

### Configuration of Internal Flow Passage 46

The peripheral wall 41 includes an internal flow passage 46 extending in the axial direction of the peripheral wall 41. The internal flow passage 46 includes a cylindrical space provided over the entire circumference inside the peripheral wall 41. Since the inner tube 42 is accommodated in the outer tube 43, the internal flow passage 46 is formed between the outer circumferential surface of the inner tube 42 and the inner circumferential surface of the outer tube 43. The upper end of the internal flow passage 46 is sealed by a first seal ring 51 disposed between the outer circumferential surface of the inner tube 42 and the inner circumferential surface of the outer tube 43. The lower end of the internal flow passage 46 is sealed by a second seal ring 52 disposed between the outer circumferential surface of the inner tube 42 and the inner circumferential surface of the outer tube 43.

A second anodized layer 40a is formed on the inner surface of the internal flow passage 46. The second anodized layer 40a is an anodic oxide film formed on the inner surface of the internal flow passage 46 by an anodizing process. The second anodized layer 40a is formed on the entire outer surface of the inner tube 42, which forms the internal flow passage 46, and the entire inner surface of the outer tube 43, which forms the internal flow passage 46.

The internal flow passage 46 includes an inlet port 47 and an outlet port 48. The inlet port 47 and the outlet port 48 extend through the outer tube 43 in the thickness direction. The inlet port 47 is provided in a portion of the peripheral wall 41 above the outlet port 48.

As shown in FIG. 1, the inlet port 47 is connected to the coolant discharge port 27 via a first cooling pipe 13. The inlet port 47 introduces the coolant C discharged from the coolant discharge port 27 into the internal flow passage 46. The outlet port 48 is connected to the coolant supply port 26 via a second cooling pipe 14. The outlet port 48 delivers the coolant C from the internal flow passage 46 to the coolant supply port 26. A pump 61 is installed in the second cooling pipe 14 to circulate the coolant C toward the coolant supply port 26.

The coolant C circulates through the circulation passage. The circulation passage includes the interior of the fuel cell 20, which includes the coolant supply port 26 and the coolant discharge port 27, the first cooling pipe 13, the internal flow passage 46 of the holder 40, and the second cooling pipe 14.

The coolant C flowing through the interior of the fuel cell 20 cools the fuel cell 20, which generates heat during power generation. At this time, since heat is exchanged between the coolant C and the fuel cell 20, the temperature of the coolant C rises. The coolant C having an increased temperature is discharged from the coolant discharge port 27 and then introduced into the internal flow passage 46 of the holder 40 via the inlet port 47. When the coolant C flows through the internal flow passage 46, the canister 30, the temperature of which decreases as hydrogen gas is released from the hydrogen storage alloy, is heated via the holder 40. At this time, since heat is exchanged between the coolant C and the holder 40, the temperature of the coolant C decreases. The coolant C having a decreased temperature is delivered to the coolant supply port 26 of the fuel cell 20 via the outlet port 48. The fuel cell 20 is thus cooled.

In the fuel cell system 10, the coolant C flows through the internal flow passage 46, so that the canister 30 is heated by the coolant C that has received the waste heat of the fuel cell 20. This suppresses a decrease in the temperature of the canister 30, and therefore also suppresses a decrease in the temperature of the hydrogen storage alloy. Accordingly, a decrease in the amount of hydrogen gas released from the hydrogen storage alloy, that is, the amount of hydrogen gas supplied to the fuel cell 20, is suppressed.

### Operation of the Present Embodiment

In the fuel cell system 10, the first anodized layer 30a is formed on the outer surface of the canister 30. This increases the strength of the outer surface of the canister 30. Accordingly, the outer surface of the canister 30 is prevented from being damaged when the canister 30 is attached to or detached from the holder 40; for example, when the canister 30 is replaced. Further, unlike a case in which a coating film is formed on the outer surface of the canister 30 using a resin coating material, it is possible to suppress a decrease in the thermal conductivity of the outer surface of the canister 30 due to the protection of the outer surface of the canister 30.

### Advantages of the Present Embodiment

(1) The fuel cell system 10 includes the fuel cell 20, the canister 30, which supplies hydrogen gas to the fuel cell 20, and the holder 40, in which the canister 30 is removably accommodated. The fuel cell system 10 heats the canister 30 using the waste heat of the fuel cell 20. The canister 30 is made of aluminum or an aluminum alloy. The first anodized layer 30a is formed on the outer surface of the canister 30.

The above-described configuration achieves the above advantages and therefore enables both protection of the outer surface of the canister 30 and suppression of a decrease in the thermal conductivity of the canister 30.

(2) The peripheral wall 41, which is in contact with the first anodized layer 30a, has the internal flow passage 46, through which the coolant C that exchanges heat with the waste heat of the fuel cell 20 flows.

According to the above-described configuration, since the peripheral wall 41 is in contact with the canister 30 through the first anodized layer 30a, heat is exchanged between the coolant C flowing through the internal flow passage 46 and the canister 30 via the peripheral wall 41. Accordingly, the heat exchange efficiency between the fuel cell 20 and the canister 30 can be increased.

(3) The base material made of aluminum or aluminum alloy is exposed on the inner surface of the peripheral wall 41, which is in contact with the first anodized layer 30a.

The above-described configuration suppresses a decrease in the thermal conductivity of the inner surface of the peripheral wall 41, as compared with a case in which a protective layer such as an anodized layer is formed on the inner surface of the peripheral wall 41.

(4) The second anodized layer 40a is formed on the inner surface of the internal flow passage 46.

In order to increase the heat exchange efficiency between the coolant C and the canister 30 via the peripheral wall 41, it is preferable that the base material of aluminum or an aluminum alloy be exposed on the inner surface of the internal flow passage 46. However, in this case, the inner surface of the internal flow passage 46 may be corroded by the coolant C flowing through the internal flow passage 46.

In this regard, according to the above-described configuration, the second anodized layer 40a is formed on the inner surface of the internal flow passage 46. This suppresses corrosion of the inner surface of the internal flow passage 46. When the second anodized layer 40a is formed in the internal flow passage 46, the thermal conductivity of the inner surface of the internal flow passage 46 is reduced as compared with a case in which the base material made of aluminum or aluminum alloy is exposed on the inner surface of the internal flow passage 46. However, unlike a case in which a coating film is formed on the inner surface of the internal flow passage 46 using a resin coating material, it is possible to suppress a decrease in the thermal conductivity of the inner surface of the internal flow passage 46 due to the protection of the inner surface of the internal flow passage 46.

(5) The internal flow passage 46 is formed between the outer surface of the inner tube 42 and the inner surface of the outer tube 43.

According to the above-described configuration, since the inner tube 42 and the outer tube 43 are separated from each other, the state of the inner surface of the internal flow passage 46, on which the second anodized layer 40a is formed, is easily checked. This facilitates checking of the deterioration of the second anodized layer 40a.

### Modifications

The above-described embodiment may be modified as follows. The above-described embodiment and the following modifications can be combined as long as the combined modifications remain technically consistent with each other.

The holder 40 may include, instead of the peripheral wall 41, a pipe that can hold the canister 30 and through which the coolant C flows. Such a pipe may be, for example, a helical pipe surrounding the outer circumferential surface of the canister 30.

The internal flow passage 46 does not necessarily need to be cylindrical. The internal flow passage 46 does not necessarily need to be continuous in the circumferential direction of the peripheral wall 41. For example, the cross-sectional shape of the internal flow passage 46 orthogonal to the axial direction of the peripheral wall 41 may be C-shaped.

The second anodized layer 40a may be formed on only one of the outer surface of the inner tube 42 and the inner surface of the outer tube 43.

The second anodized layer 40a does not necessarily need to be formed on the inner surface of the internal flow passage 46.

The holder 40 does not necessarily need to include the internal flow passage 46. In this case, it is sufficient that the heating medium be directly supplied to the outer surface of the canister 30 within the interior of the holder 40.

An anodized layer similar to the first anodized layer 30a may be formed on a portion of the inner surface of the holder 40 that is in contact with the first anodized layer 30a.

A clearance may be provided between the inner surface of the inner tube 42 and the first anodized layer 30a.

The heating medium does not necessarily need to be supplied from the canister 30 to the fuel cell 20 as long as the heating medium supplies the waste heat of the fuel cell 20 to the canister 30. In other words, the heating medium does not necessarily need to be circulated between the fuel cell 20 and the canister 30.

The heating medium may be a liquid different from water. The heating medium may be a gas such as air.

The first anodized layer 30a may be formed on the bottom surface, which is a part of the outer surface of the canister 30. In this case, the bottom surface of the canister 30 may be in contact with the inner surface of the cap 45.

The first anodized layer 30a may be formed on the outer surface of the discharge port 31.

The second anodized layer 40a may be formed on the inner circumferential surface of the inlet port 47 and the inner circumferential surface of the outlet port 48.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuitry are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A fuel cell system, comprising:
a fuel cell;
a canister incorporating a hydrogen storage alloy that stores and releases hydrogen gas, the canister being configured to supply hydrogen gas to the fuel cell; and
a holder in which the canister is removably accommodated, wherein
the fuel cell system is configured to heat the canister using waste heat of the fuel cell,
the canister is formed of aluminum or an aluminum alloy, and
an anodized layer is formed on an outer surface of the canister.

2. The fuel cell system according to claim 1, wherein
the holder includes a peripheral wall in contact with the anodized layer, and
the peripheral wall includes an internal flow passage, the internal flow passage being configured such that a heating medium that exchanges heat with the waste heat of the fuel cell flows through the internal flow passage.

3. The fuel cell system according to claim 2, wherein aluminum or an aluminum alloy is exposed on an inner surface of the peripheral wall.

4. The fuel cell system according to claim 2, wherein
the anodized layer is a first anodized layer,
the peripheral wall is formed of aluminum or an aluminum alloy, and
a second anodized layer is formed on an inner surface of the internal flow passage.

5. The fuel cell system according to claim 4, wherein
the peripheral wall includes an inner tube and an outer tube that accommodates the inner tube, and
the internal flow passage is formed between an outer surface of the inner tube and an inner surface of the outer tube.
